(19) United States
(12) Patent Application Publication
(10) Pub. No.: US 2025/0292205 A1
(43) Pub. Date: Sep. 18, 2025

(54) MACHINE LEARNING METHOD FOR LOGISTICS AUTOMATION

(71) Applicant: MIDL, Seoul (KR)

(72) Inventor: WANSEOP LEE, Seoul (KR)

(73) Assignee: MIDL, Seoul (KR)

(21) Appl. No.: 19/074,473

(22) Filed: Mar. 10, 2025

(30) Foreign Application Priority Data
Mar. 12, 2024 (KR) 10-2024-0034316

(51) Int. Cl. G06Q 10/087; G06K 19/06; G06N 20/20

(52) U.S. Cl. CPC G06Q 10/087; G06K 19/06009; G06N 20/20

(57) ABSTRACT

The present invention relates to a method for building a multimodal dataset, a learning method using the same, and an artificial intelligence-based logistics processing method using the same. The invention includes, in a computer-implemented method: extracting data from a target site; filtering the extracted data to display the desired information to the customer; extracting and storing the order product name, which is the name of the product displayed, and the order image, which is the image of the product displayed, when the customer places an order; scanning and storing the unique code displayed on the incoming product; and determining whether the unique code corresponds to learned data, and if it does not, downloading the verification product name and verification image corresponding to the unique code.

### CROSS-REFERENCE TO RELATED APPLICATION

This application claims the benefit of priority under 35 U.S.C. § 119(a) to Korean Patent Application No. 10-2024-0034316 filed on Mar. 12, 2024, the entire contents of which are incorporated herein by reference.

### BACKGROUND OF THE INVENTION

The present invention relates to a machine learning method and an order processing and logistics automation method using the same. More specifically, it pertains to a method for automating logistics processing by utilizing extracted data and data obtained from incoming products, as well as a method for constructing data that can be used to train an artificial intelligence (AI) model.

The importance of data in modern logistics and supply chain management is continuously increasing. In particular, with the advancement of internet technology and e-commerce, online product transactions have surged, making it crucial to effectively utilize the vast amount of data generated from various websites.

Recently, by applying multimodal learning methods, models can extract key features from different data modalities and combine them to make more accurate predictions.

However, selecting and labeling the data required for training still requires significant time and cost. Therefore, there is a need to develop a technology that can automatically extract and label the necessary data to train an AI model and utilize it for logistics processing.

### SUMMARY OF THE INVENTION

Therefore, there is a need for an automated method to accurately determine whether the incoming products match the products ordered by customers, as well as a method to automatically extract and label data for training an AI model using customer order information. This enables the trained AI model to be applied to logistics processing, thereby establishing a fast and accurate logistics processing system.

The various aspects of the disclosed technologies involve a method implemented on a computing system, which includes assigning a unique code to a product and registering the corresponding validated product name, validated image, and data related to the unique code on an external server, copying and storing the data from the external server, and using this data, along with the validated product name, validated image, and unique code, to judge the similarity between images and text based on the customer's order information, extracting data from a target site, filtering the extracted data to display the desired information to the customer, extracting and storing the order product name and order image displayed on the customer order screen, scanning and storing the unique code displayed on the incoming product, and determining whether the validated product name and validated image corresponding to the unique code have been learned in the model, and if they have not been learned, downloading the corresponding validated product name and validated image.

The various aspects of the disclosed technologies involve a method implemented on a computing system, which includes determining the arrival date of the incoming product based on the time the unique code is scanned and stored and predicting the order date based on the arrival date.

The various aspects of the disclosed technologies involve a method implemented on a computing system, which includes searching for the validated product name and validated image corresponding to the scanned unique code in the computing system's storage device or an external server if the scanned unique code is already learned data, and retrieving the order product name and order image corresponding to the validated product name and validated image based on the order date.

The various aspects of the disclosed technologies involve a method implemented on a computing system, which includes determining that the accuracy of the trained model is low if the order product name and order image corresponding to the validated product name and validated image do not exist, and setting the validated product name and validated image corresponding to the scanned unique code as training data.

The various aspects of the disclosed technologies involve a method implemented on a computing system, which includes issuing a shipment command for the received product if the validated product name and validated image corresponding to the unique code match the order product name and order image, and assigning a storage location for the received product based on the fastest order sequence.

The aspects of the disclosed technology comprise a method implemented in a computing system, including a step of displaying the storage location of the received product and outputting a movement command message.

The aspects of the disclosed technology comprise a method implemented in a computing system, including a step of extracting GTIN information from the scanned unique code.

The aspects of the disclosed technology comprise a method implemented in a computing system, wherein the verified product name and verified image are matched with the extracted GTIN information.

The aspects of the disclosed technology comprise a method implemented in a computing system, including a step of counting the order quantity based on at least one of the order product name corresponding to the verified product name or the order product image corresponding to the verified image on the predicted order date.

The aspects of the disclosed technology comprise a method implemented in a computing system, further including a step of labeling the remaining information with at least one of the order product name, order image, verified product name, or verified image when the predicted order quantity matches the actual received quantity, and classifying it into a dataset with high accuracy.

The aspects of the disclosed technology comprise a method implemented in a computing system, including a step of labeling the remaining information with at least one of the order product name, order image, verified product name, or verified image and classifying it into a dataset with low accuracy when the predicted order quantity does not match the actual received quantity.

The aspects of the disclosed technology include a method implemented in a computing system, comprising the steps of extracting data from a target site; filtering the extracted data to display the desired information to the customer; extracting and storing the order product name and order image, which are displayed as the product name and image of the product ordered by the customer; scanning and storing the unique code displayed on the received product;

verifying whether the verified product name and verified image corresponding to the unique code match the order product name and order image; and, based on the timestamp when the unique code is scanned and stored, determining the arrival date of the received product and predicting the order date based on the arrival date.

The aspects of the disclosed technology include a method implemented in a computing system, comprising the step of labeling the remaining information on at least one of the order product name, order image, verified product name, and verified image, if the number of order product names and verified product names matches based on the predicted order date.

The aspects of the disclosed technology include a method implemented in a computing system, comprising the step of labeling the remaining information on at least one of the order product name, order image, verified product name, and verified image, if the number of order product names and verified product names does not match based on the predicted order date; and performing ensemble learning using the matching and mismatching information.

The aspects of the disclosed technology also include a method implemented in a computer, comprising the steps of extracting and storing the order product name, which is the product name displayed on the customer's terminal, and the order image, which is the product image displayed on the customer's terminal, when the customer places an order through a website; scanning and storing the unique code displayed on the product upon its arrival at the logistics warehouse; determining whether the corresponding verified product name and verified image for the unique code are learned data, and if not, downloading the corresponding verified product name and verified image; and if the order product name and order image corresponding to the verified product name and verified image do not exist, setting the unique code as a learning target. Here, the verified product name is the product name registered by the entity that assigned the unique code, and the verified image is the product image registered by the entity that assigned the unique code. The downloading is executed by a computing system that copies data from an external server where the unique code, verified image, and verified product name are stored, and the computing system, when the unique code is entered, learns the information of the verified product name and verified image to determine the similarity between the image and text from the customer's order information.

### BRIEF DESCRIPTION OF THE DRAWINGS

FIG. 1 is a block diagram of an exemplary computing system (10) according to various embodiments of the disclosed technologies.

FIG. 2 is a block diagram of an exemplary logistics processing system according to various embodiments of the disclosed technologies.

FIG. 3 is a flowchart illustrating the data extraction process according to various embodiments of the disclosed technologies.

FIG. 4 is a flowchart of operation “R” in FIG. 3.

FIG. 5 is a flowchart of operation “S” in FIG. 4.

FIG. 6 illustrates the storage and movement of incoming products according to various embodiments of the disclosed technologies.

FIG. 7 is a flowchart of operations “L” in FIG. 4 and “L” in FIG. 5.

### DETAILED DESCRIPTION OF THE INVENTION

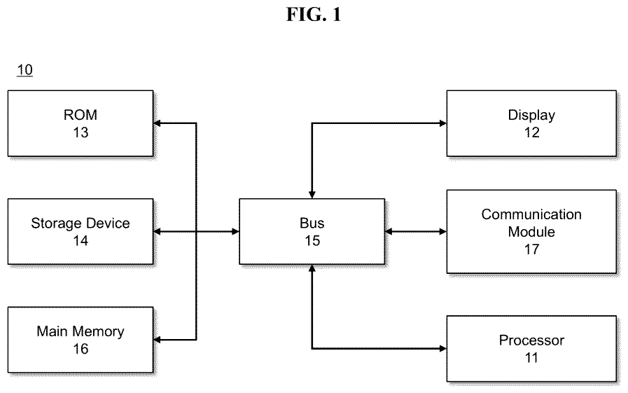

The advantages and features of the present invention, and the methods for achieving them, will become clear with reference to the embodiments described in detail below along with the accompanying drawings. However, the present invention is not limited to the embodiments disclosed below and can be implemented in various other forms, and the embodiments are provided only to ensure that the disclosure of the present invention is complete and to fully inform those skilled in the art of the scope of the invention, and the present invention is defined only by the scope of the claims. Throughout the specification, the same reference numerals refer to the same components. Hereinafter, the present invention will be described with reference to the drawings. FIG. 1 is a block diagram of an exemplary computing system (10) according to various embodiments of the disclosed technologies. Referring to FIG. 1, the computing system (10) is an electronic system capable of processing and storing data, including hardware and software. The computing system or computing device (10) may include components such as a data processing system or be used to implement them. The computing system (10) also includes a bus (15) or other communication components for communication of information and a processor (11) or processing circuits connected to the bus (15) for processing the information. The computing system (10) may further include one or more processors (11) or processing circuits connected to the bus to process information.

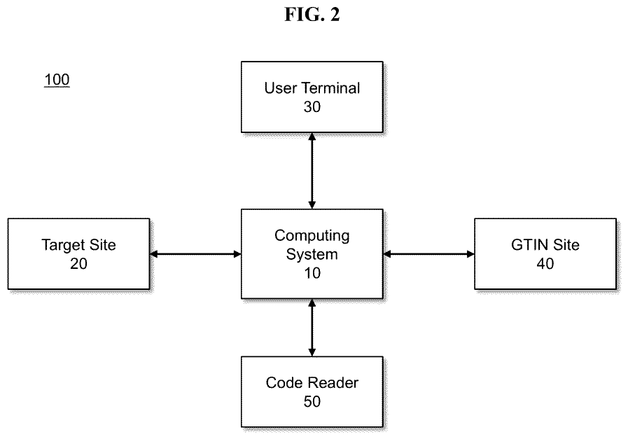

The computing system (10) also includes a main memory (16) connected to the bus (15), such as random access memory (RAM) or another dynamic storage device, to store instructions executed by the processor (11). The main memory (16) can also be used to store location information, temporary variables, or other intermediate information during the execution of instructions by the processor (11). The computing system (10) may further include a read-only memory (ROM) (13) or another static storage device connected to the bus (15) to store static information and instructions for the processor (11). Storage devices (14), such as solid-state devices (SSD), magnetic disks, or optical disks, may be connected to the bus (15) to permanently store information and instructions. The computing system (10) can be connected to a display (12), such as a liquid crystal display or an active matrix display, through the bus (15) to display information to the user. The computing system is connected to a network through a communication module (17). The computing system is connected to local networks (LAN), wide-area networks (WAN), the internet, or the cloud. The communication module (17) enables the computing system to send and receive data with other computers or external servers (clients) on the network. The external server refers to servers of other companies, such as the target site (20) server or the GTIN site (40) server described later in FIG. 2. The data storage refers to the storage devices (14) of the computing system (10) and external servers. The storage device (14) merges and stores data obtained from external servers and its own data.

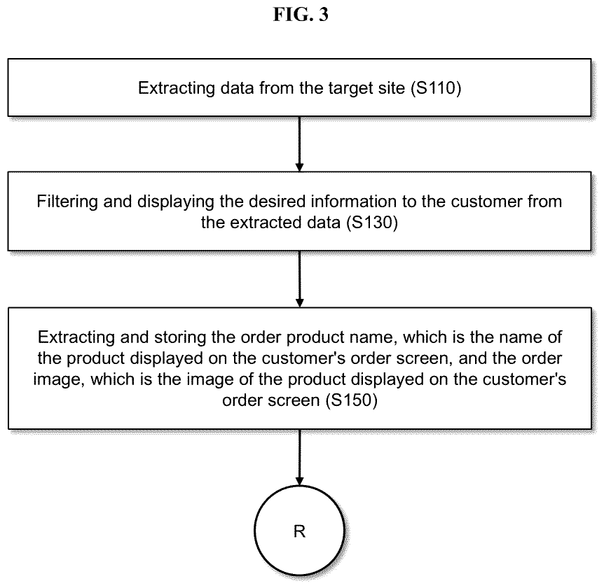

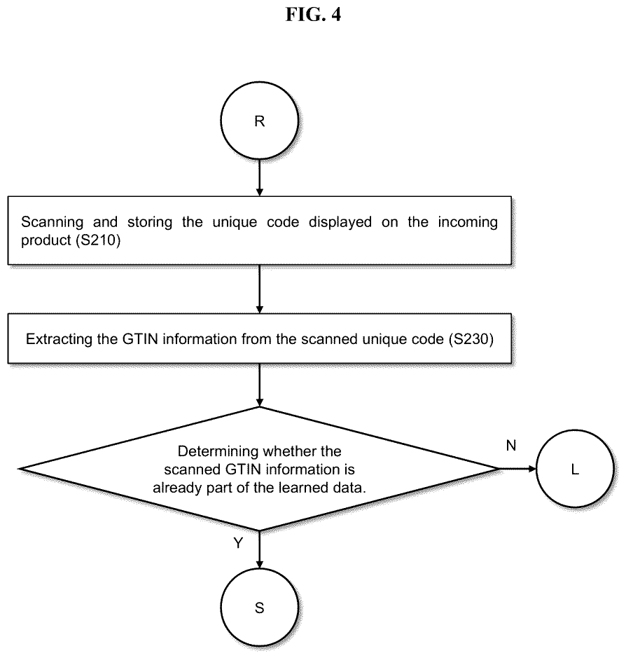

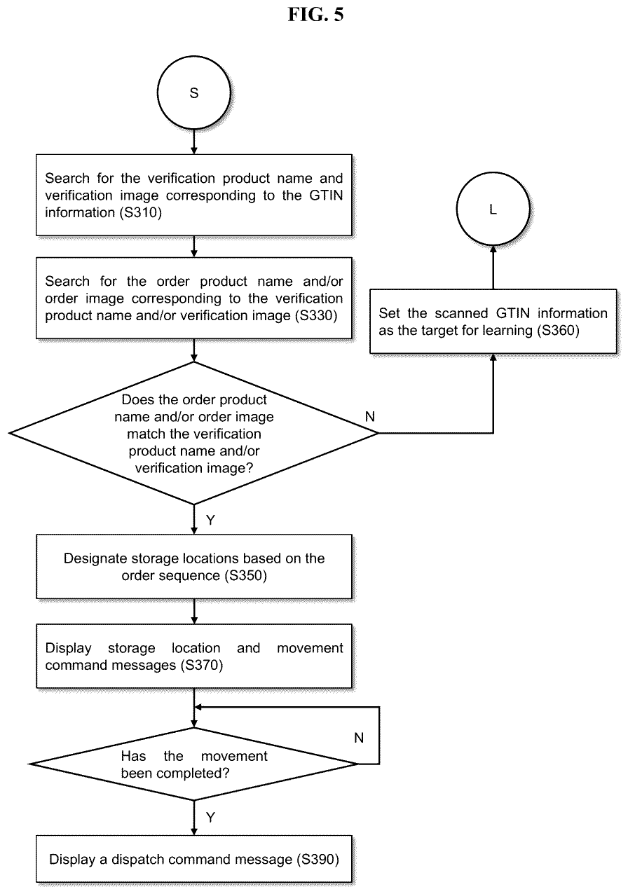

FIG. 2 is a block diagram of an exemplary logistics processing system (100) according to various embodiments of the disclosed technologies. FIG. 3 is a flowchart illustrating the data extraction process according to various embodiments of the disclosed technologies. FIG. 4 is a flowchart of operation “R” in FIG. 3. FIG. 5 is a flowchart of operation “S” in FIG. 4.

Referring to FIG. 2 through 5, the disclosed various aspects include a method implemented on a computer, comprising the following steps: extracting data from a target site (20) (S110); filtering desired information from the extracted data and displaying it to the customer (S130); when an order is made by the customer, extracting and storing the product name (order product name) and the product image (order image) displayed on the product (S150); scanning and storing the unique code displayed on the incoming product (S210); extracting GTIN information from the stored unique code (S230); and when the verification product name and verification image corresponding to the unique code match the order product name and order image, issuing a shipping command for the incoming product (S390).

The computing system (10) extracts data from the target site (20). It then displays the desired information (such as price, seller information, discount price, shipping information, image, product name, and options) from the extracted data to the user terminal (30).

Web scraping is an automated method of extracting information from web pages. The computing system (10) uses web scraping technology to collect structured data, such as product names, image URLs, product codes, and seller information, from the target site. Data crawling is a process similar to web scraping, where web pages are automatically explored to collect data.

The computing system (10) uses crawling technology, which is primarily used for exploring large-scale website structures on the target site, while scraping focuses on extracting specific data from the pages discovered. In this specification, the term “extracting data from the target site” refers to using either crawling technology, scraping technology, or both.

The computing system (10) extracts data from the target site (20), filters it, and displays the information on a separate website that is searchable by the user.

When the customer completes the order, the computing system (10) stores the order product name and order image in the storage device (14).

When the ordered product arrives at the logistics warehouse, the unique code displayed on the packaging of the incoming product is scanned. The code reader (50) scans the unique code manually or automatically. The unique code is stored in the storage device (14) of the computing system (10).

The computing system (10) requests the product information corresponding to the unique code from either the storage device (14) or an external server. The product information may include the verification product name (the product's name) and the verification image (the product's image).

The computing system (10) compares the order product name with the verification product name and compares the order image with the verification image. If at least one of them, preferably both, match, the system issues a shipping command for the product.

The verification product name is the name of the product registered by the entity that assigned the unique code and corresponds to the product associated with the unique code.

The disclosed various aspects of the technology include the following steps: when the scanned unique code corresponds to already learned data, the step of searching for the verification product name and verification image corresponding to the unique code (S310); and the step of searching for the order product name and order image corresponding to the verification product name and verification image based on the order date (S330).

The computing system (10) can request information about the unique code from an external server. For example, the unique code could be a GTIN (Global Trade Item Number). The GTIN is a numerical system used globally to uniquely identify products and services. There are several formats of GTIN, and they consist of numbers of varying lengths depending on the type of product or location. The computing system (10) requests the product name and image corresponding to the GTIN from the GTIN site (40).

If the GTIN of the incoming product has already been learned, the computing system (10) does not request information from the GTIN site (40) but instead uses the learned model to assess the similarity between the verification product (or verification image) and the order product name (or order image), or to perform a comparison with stored data. The learned model can analyze and determine the relationship between the verification product name and verification image corresponding to the unique code. The verification image is registered by the entity that assigned the unique code and corresponds to the product's image associated with the unique code.

The disclosed various aspects of the technology include the following step: if the order product name and order image corresponding to the verification product name and verification image do not exist, determining that the accuracy of the learned model for the scanned unique code is low and setting the unique code as a learning target (S360). The computing system (10) judges that there is insufficient information about the GTIN or that the accuracy of the model is low if matching information is not found.

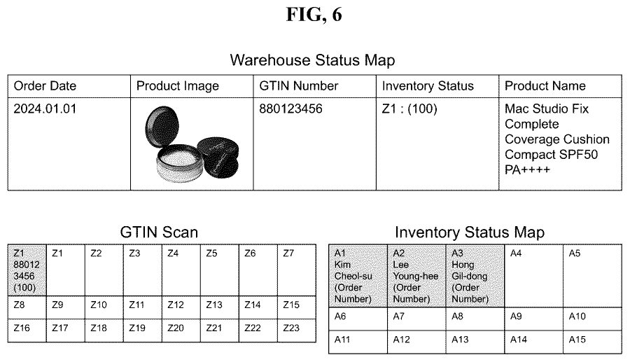

FIG. 6 illustrates the storage and movement of incoming products according to various embodiments of the disclosed technology.

Referring to FIG. 6, the disclosed aspects of the technology include the step of designating storage locations for incoming products based on the order sequence (S350). The computing system (10) designates storage locations in the order of the incoming products when matching information is found. The order sequence may be based on the order date, or if there are multiple orders on the same date, it may be based on the time.

The disclosed aspects also include the step of displaying the storage location of the incoming products and the movement command message (S370). The computing system (10) specifies the storage location for products that pass verification and displays it on the display (12). The computing system (10) can display a command to move the incoming products to the designated storage location on the display (12). Alternatively, the computing system (10) may simply display the storage location for the incoming product without displaying the movement command.

The step of commanding the outgoing of the incoming product (S390) includes displaying an outgoing command message when the product has been moved to the storage location. The computing system (10) issues the outgoing command when the movement of the incoming product is confirmed, and it is verified that the product is present in the storage location. The outgoing command may be displayed on the display (12).

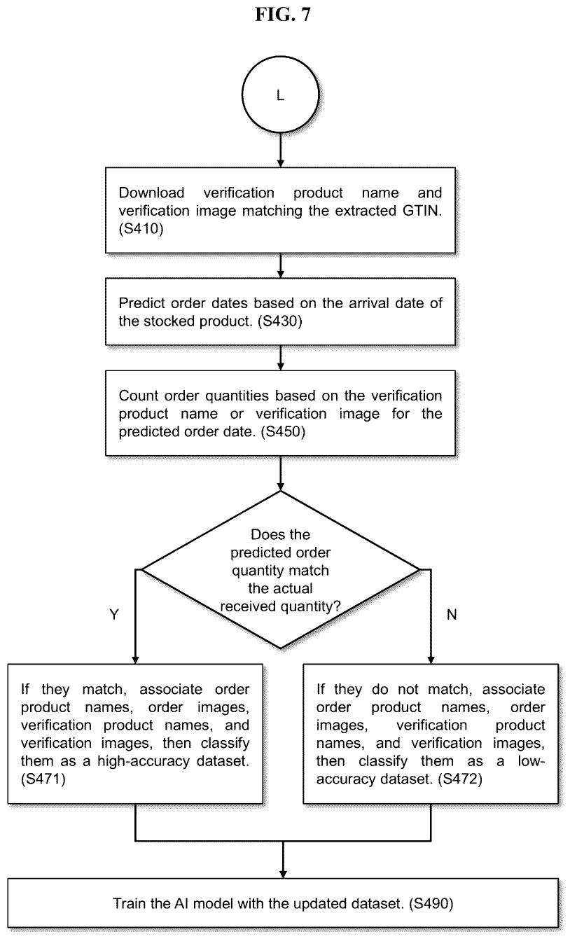

FIG. 7 is a flowchart for the “L” operation in FIG. 4 and FIG. 5.

Referring to FIG. 7, the verification product name and verification image may correspond to the information that matches the extracted GTIN information (S410).

The disclosed technology includes the step of determining whether the unique code is associated with learned data. If it is determined that the data has not been learned, the system downloads the verification product name and verification image corresponding to the unique code (S410). The computing system (10) requests the verification product name and verification image from the GTIN site (40) when it determines that the extracted GTIN information from the scanned unique code has not been learned by the artificial intelligence model or is of low accuracy.

The disclosed technology also includes the step of predicting the order date based on the arrival date of the incoming product (S430).

Furthermore, the disclosed technology includes the step of counting the order quantity based on at least one of the verification product name matching the order product name or the verification image matching the order product image from the predicted order date (S450). The computing system (10) predicts the order date based on the arrival date of the incoming product. For example, if the system extracts information that the product is to be shipped on the same day, the order date is the arrival date. Alternatively, if the system extracts information that the product is to be shipped the following day, the order date is the next day. The computing system (10) compares the predicted order quantity for the estimated order date with the incoming quantity on the actual delivery date to assess the accuracy of the data.

The various aspects of the disclosed technology include a step (S471) in which, if the predicted order quantity matches the actual arrival quantity, at least one of the order product name, order image, verification product name, or verification image is labeled with the remaining information, and classified into a high-accuracy dataset.

The various aspects of the disclosed technology include a step (S472) in which, if the predicted order quantity does not match the actual arrival quantity, at least one of the order product name, order image, verification product name, or verification image is labeled with the remaining information, and classified into a low-accuracy dataset.

The various aspects of the disclosed technology include a step (S430) in which the order date is predicted based on the arrival date of the incoming product; and a step (S471) in which, if the predicted order date matches the order product name and verification product name, at least one of the order product name, order image, verification product name, or verification image is labeled with the remaining information.

The various aspects of the disclosed technology include a step (S472) in which, if the predicted order date does not match the order product name and verification product name, at least one of the order product name, order image, verification product name, or verification image is labeled with the remaining information; and a step (S490) in which ensemble learning is performed using both matching and non-matching information. The computing system (10) executes data labeling. Data labeling is the process of assigning explicit labels (e.g., order product name, verification product name) to each data point (e.g., incoming image, verification image) for machine learning model training. This provides the information needed for the model to learn patterns in supervised learning.

The computing system (10) may perform multi-label classification.

For various pieces of information (e.g., product name, seller, GTIN, order product name, verification product name, order image, verification image, etc.), the system can label other remaining information. Multi-label classification deals with the problem where a single instance can have multiple labels simultaneously.

The computing system (10) can split the labeled data into a training set, a validation set, and a test set.

The artificial intelligence model may be CNN, RNN, or Transformer, and it may also be a multimodal model that combines these to simultaneously process various types of data, such as images and text.

A multimodal model can combine CNN and RNN or Transformer to process both image and text data simultaneously and learn the relationships between the two modalities.

The computing system (10) can store both high-accuracy and low-accuracy datasets and adjust their proportions for model training.

The computing system (10) can perform training with noise, i.e., include noisy data in the training dataset, allowing the model to learn robust characteristics against noise. This makes the model capable of handling various types of data in real-world environments.

The computing system (10) can separate datasets. The computing system (10) can separate high-accuracy data from noisy data, train separate models for each, and then execute an ensemble technique to integrate the results.

According to the various technologies disclosed above, shopping mall users can directly select and purchase products from the target site. The computing system (10) requests the target site to transport the purchased product to a separate designated location. When the product arrives at the designated location, the computing system (10) inspects the incoming product to confirm whether the product purchased by the shopping mall user matches the received product. If the computing system (10) determines that the product purchased by the shopping mall user matches the incoming product, it will either instruct the product to be shipped to the shopping mall user's address or order the product to be moved to another location.

If the computing system (10) determines that data learning is necessary, it will automatically label the associated data of the unique code and perform the learning.

The actions are depicted in a specific sequence in the drawings, but it is not required that these actions be performed in the exact order shown or in a chronological sequence, nor is it necessary for all depicted actions to be carried out. The actions described in this specification can be performed in different orders.

Although some exemplary implementations have been described, the examples provided are illustrative and not restrictive, and they are presented as examples. In particular, many examples presented in this specification involve specific combinations of method actions or system elements, but such actions and elements can be combined in different ways to achieve the same purpose.

The phrases and terms used in this specification are for the purpose of explanation and should not be considered limiting. Terms such as “including,” “comprising,” “having,” “containing,” “involving,” “characterized by,” “characterized in that,” and their variations in this specification refer to alternative embodiments that include the listed items, their equivalents, and additional items, as well as implementations consisting exclusively of the listed items. In one embodiment, the systems and methods described in this specification are made up of one or more of the elements, actions, or components described.

Any embodiment disclosed in this specification may be combined with any other embodiment or example, and terms like “embodiment,” “some embodiments,” and “one embodiment” are not mutually exclusive, indicating that the specific configuration, structure, or characteristics described in relation to an embodiment may be included in at least one embodiment.

The terms used in this specification do not necessarily refer to the same embodiment. Any embodiment may be combined with any other embodiment disclosed in this specification in a comprehensive or exclusive manner, consistent with the forms and embodiments disclosed.

A reference to “or” can be interpreted broadly to mean that any term described using “or” can represent one, more than one, or all of the terms described. A reference to “at least one of A and B” can include A, B, or both A and B. Such references used with “including” or other open-ended terms can encompass additional items.

In cases where reference numerals are provided in the drawings, detailed description, or claims, these reference numerals are included to increase clarity of the drawings, detailed description, and claims. Therefore, the presence or absence of reference numerals does not limit the scope of any claim elements.

The systems and methods described in this specification may be embodied in other specific forms without departing from their characteristics. The aforementioned embodiments are exemplary and not intended to limit the systems and methods described. Therefore, the scope of the systems and methods described in this specification is indicated by the appended claims, and changes within the meaning and scope of the claims are also included.

What is claimed is:

1. A method implemented by a computing system storing a model for determining the similarity of images and text from customer order information, using data on the verification product name, verification image, and the unique code registered by the entity assigning the unique code to the corresponding product, where the unique code, verification product name, and verification image are stored on an external server and copied and stored, comprising:
extracting data from a target site;
filtering the extracted data to display the desired information to the customer;
extracting and storing the order product name, which is the name of the product displayed on the order screen, and the order image, which is the image of the product displayed;
scanning and storing the unique code displayed on the received product;
determining whether the verification product name and verification image corresponding to the unique code are data learned by the model, and if they are not learned data, downloading the verification product name and verification image corresponding to the unique code.

2. The method of claim 1, further comprising:
predicting an order date based on a received product's arrival date, which is determined based on the time when the unique code is scanned and stored.

3. The method of claim 1, further comprising:
searching for the verification product name and verification image corresponding to the unique code in the computing system's storage device or an external server, when the scanned unique code is already part of the learned data; and
searching for the order product name and order image corresponding to the verification product name and verification image based on the order date.

4. The method of claim 2, further comprising:
when the order product name and order image corresponding to the verification product name and verification image do not exist,
determining that the accuracy of the model that learned the verification product name and verification image corresponding to the scanned unique code is low, and setting the verification product name and verification image corresponding to the unique code as a subject for learning.

5. The method of claim 1, further comprising:
when the verification product name and verification image corresponding to the unique code match the order product name and order image, commanding the shipment of the received product; and
designating a storage location for the received product in the order of the fastest order.

6. The method of claim 5, further comprising:
displaying a storage location indication and a relocation command message for the received product.

7. The method of claim 1, further comprising:
extracting GTIN information from the scanned unique code.

8. The method of claim 7, wherein the verification product name and verification image are information that matches the extracted GTIN information.

9. The method of claim 2, further comprising:
counting the order quantity based on at least one of the order product name corresponding to the verification product name or the order product image corresponding to the verification image for the predicted order date.

10. The method of claim 9, further comprising:
if the predicted order quantity matches the actual received quantity, labeling the remaining information in at least one of the order product name, order image, verification product name, or verification image, and classifying it into a high-accuracy data set.

11. The method of claim 9, further comprising:
if the predicted order quantity and the actual received quantity do not match, labeling the remaining information in at least one of the order product name, order image, verification product name, or verification image, and classifying it into a low-accuracy data set.

12. A method implemented by a computer, comprising:
extracting data from a target site;
filtering the extracted data to display desired information to the customer;
extracting and saving the order product name and order image corresponding to the product displayed when the customer places an order;
scanning and saving the unique code displayed on the received product;
verifying whether the verification product name and verification image corresponding to the unique code match the order product name and order image; and
determining the arrival date of the received product based on the time the unique code is scanned and saved, and predicting the order date based on the arrival date.

13. The method of claim 12, further comprising:
if the number of order product names and verification product names match based on the predicted order date, labeling the remaining information in at least one of the order product name, order image, verification product name, or verification image.

14. The method of claim 12, further comprising:
if the number of order product names and verification product names do not match based on the predicted order date, labeling the remaining information in at least one of the order product name, order image, verification product name, or verification image; and
performing ensemble learning using the matching and non-matching information.

15. A computer-implemented method comprising:
extracting and storing the order product name, which is the name of the product displayed on the customer's device, and the order image, which is the image of the product displayed on the customer's device, when the customer places an order through a website;
scanning and storing the unique code displayed on the product when the product arrives at the logistics warehouse;
determining whether the verification product name and verification image corresponding to the unique code are learned data, and if they are not learned data, downloading the verification product name and verification image corresponding to the unique code;
if the order product name and order image corresponding to the verification product name and verification image do not exist, setting the unique code as a learning target;
wherein the verification product name is the product name registered by the entity that assigned the unique code,
the verification image is the product image registered by the entity that assigned the unique code,
the downloading is performed by a computing system that copies and stores data from an external server where the unique code, verification image, and verification product name are stored, and
the computing system learns the information of the verification product name and verification image upon input of the unique code and determines the similarity between the image and text from the customer's order information.
